(19) United States
(12) Patent Application Publication
(10) Pub. No.: US 2024/0087428 A1
(43) Pub. Date: Mar. 14, 2024

(54) DISPLAY DEVICE AND DISPLAY METHOD

(71) Applicant: KYOCERA Corporation, Kyoto (JP)

(72) Inventor: Motoki ABE, Yokohama-shi, Kanagawa (JP)

(73) Assignee: KYOCERA Corporation, Kyoto (JP)

(21) Appl. No.: 18/262,009

(22) PCT Filed: Jan. 19, 2022
(86) PCT No.: PCT/JP2022/001844

§ 371 Date: Jul. 18, 2023

(30) Foreign Application Priority Data
Jan. 20, 2021 (JP) 2021-007244

(51) Int. Cl. G07G 1/01; G07G 1/00

(52) U.S. Cl. CPC G07G 1/01; G07G 1/0018; G07G 1/0045

(57) ABSTRACT

A display device includes a display, an acquirer, and a controller. The display is configured to display a display image containing identification information of a purchase item to a reader of a cash register. The acquirer is configured to acquire external output information from the cash register. The controller is configured to control a display operation of the display on the basis of the external output information. When the controller determines, on the basis of external output information of a first purchase item from the cash register, that the cash register has identified the first purchase item, the controller causes the display to display a display image containing identification information of a second purchase item.

### CROSS-REFERENCE TO RELATED APPLICATIONS

This application claims priority to Japanese Patent Application No. 2021-007244 (filed on Jan. 20, 2021), the entire disclosure of which is incorporated herein by reference.

### TECHNICAL FIELD

The present disclosure relates to a display device and a display method.

### BACKGROUND OF INVENTION

For example, Patent Literature 1 discloses a self-service cash register system that allows customers to make payment at a retail store or the like without staff intervention.

### CITATION LIST

### Patent Literature

Patent Literature 1: Japanese Unexamined Patent Application Publication No. 2016-194959

### SUMMARY

In an aspect of the present disclosure, a display device includes a display, an acquirer, and a controller. The display is configured to display a display image containing identification information of a purchase item to a reader of a cash register. The acquirer is configured to acquire external output information from the cash register. The controller is configured to control a display operation of the display on the basis of the external output information. When the controller determines, on the basis of external output information of a first purchase item from the cash register, that the cash register has identified the first purchase item, the controller causes the display to display a display image containing identification information of a second purchase item.

In another aspect of the present disclosure, a display method includes displaying a display image containing identification information of a first purchase item to a reader of a cash register; acquiring external output information from the cash register; and displaying a display image containing identification information of a second purchase item when determining, on the basis of external output information of the first purchase item from the cash register, that the cash register has identified the first purchase item.

### BRIEF DESCRIPTION OF THE DRAWINGS

FIG. 1 is a functional block diagram of a payment processing system according to first to third embodiments.

FIG. 2 is an external view of the payment processing system according to the first to third embodiments.

FIG. 3 is a functional block diagram of a display device according to the first to third embodiments.

FIG. 4 is a diagram illustrating an image of how the display device acquires external output information according to the first embodiment.

FIG. 5 is a diagram illustrating a pre-update image of external output information to be acquired by the display device according to the first embodiment.

FIG. 6 is a diagram illustrating a post-update image of external output information to be acquired by the display device according to the first embodiment.

FIG. 7 is a flowchart illustrating update and display processing in the display device according to the first embodiment.

FIG. 8 is a diagram illustrating an image of how a display device acquires external output information according to a second embodiment.

FIG. 9 is a flowchart illustrating update and display processing in the display device according to the second embodiment.

FIG. 10 is a flowchart illustrating update and display processing in a display device according to a third embodiment.

### DESCRIPTION OF EMBODIMENTS

Introducing a self-service cash register system, such as that described in Patent Literature 1, often involves replacing an existing cash register system. In view of the cost of equipment, it is preferable to introduce a self-service cash register system without replacing an existing cash register system. The present disclosure enables construction of a self-service cash register system capable of connecting to an existing cash register system.

Embodiments of a display device and a display method to which the present disclosure is applied will now be described with reference to the drawings.

### First Embodiment

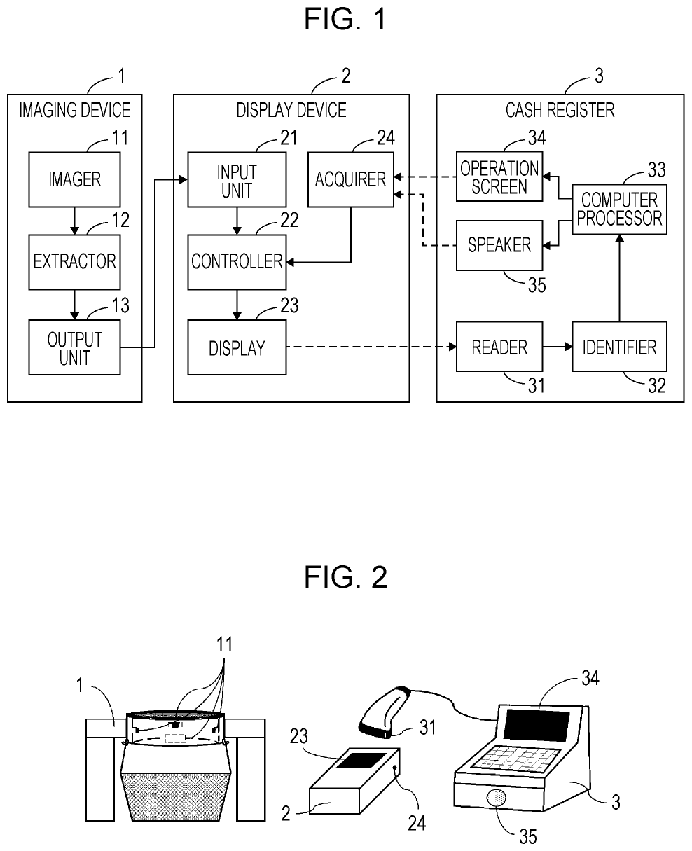

FIG. 1 and FIG. 2 are a functional block diagram and an external view, respectively, of a payment processing system according to a first embodiment.

In the first embodiment of the present disclosure, as illustrated in FIG. 1, the payment processing system includes an imaging device 1, a display device 2, and a cash register 3.

In the drawings described below, each solid arrow connecting functional blocks represents a control signal or a flow of communicated information. Communication indicated by the solid arrow may be wire communication, wireless communication, or a combination of both. For wireless communication, the imaging device 1, the display device 2, or the cash register 3 may include a communication module for communication compliant with various wire/wireless communication standards including, for example, Bluetooth (registered trademark) IEEE 802.3 or IEEE 802.11. The wireless communication may be optical communication.

In the drawings described below, each broken arrow connecting functional blocks represents, for example, a flow of information sent from the functional block at the start point of the arrow and acquired by the functional block at the end point of the arrow.

As illustrated in FIG. 1, the imaging device 1 includes an imager 11, an extractor 12, and an output unit 13.

The imager 11 captures an image of an imaging object and generates a captured image of the imaging object.

The imager 11 includes a camera. The camera includes an imaging optical system and an imaging element. The imaging optical system includes, for example, optical members, such as one or more lenses and an aperture stop. The lens may be a lens of any focal length. For example, the lens may be a commonly used lens, a wide-angle lens such as a fisheye lens, or a zoom lens with a variable focal length. The imaging optical system forms a subject image on a light receiving surface of the imaging element. The imaging element is, for example, a charge coupled device (CCD) image sensor or a complementary metal-oxide semiconductor (CMOS) image sensor. The imaging element captures the subject image formed on the light receiving surface and generates a captured image. The imager 11 may continuously capture still images at any frame rate. Continuously capturing still images may mean capturing a moving image.

From the captured image captured by the imager 11, the extractor 12 extracts identification information for identifying the type of the imaging object.

The identification information may be, for example, a one-dimensional barcode, such as a Japan Article Number (JAN) code, or a two-dimensional barcode, such as a QR code (registered trademark). Generally, using identification information makes it possible to identify the item name or the price of the imaging object, and perform payment processing, sales management, and inventory and purchase management.

To extract identification information, the extractor 12 may use an object recognition technique based on, for example, pattern matching or machine learning. As the object recognition technique for extracting identification information, the extractor 12 may use a known technique, such as a detection network or sliding window detection.

For the extractor 12 to extract identification information, for example, the extractor 12 may trim the first image to include identification information and generate a new image.

The extractor 12 includes a processor and a memory. The processor may be a central processing unit (CPU), a graphics processing unit (GPU), or a field-programmable gate array (FPGA). The memory may be a semiconductor memory, a magnetic memory, or an optical memory. The semiconductor memory may be a volatile memory or a non-volatile memory. The magnetic memory may be, for example, a hard disk or a magnetic tape. The optical memory may be, for example, a compact disc (CD), a digital versatile disc (DVD), or a Blu-ray (registered trademark) disc (BD).

The memory included in the extractor 12 may store various types of information or parameters related to the operation of the imaging device 1. The memory may store programs executed by the extractor 12. The memory may function as a working memory for the extractor 12. The memory may store the first image or identification information.

The output unit 13 outputs identification information acquired by the extractor 12 to an input unit 21 of the display device 2.

FIG. 2 illustrates an example in which the output unit 13 is connected to the input unit 21 wirelessly, not by a wire. As described in paragraph (0012), however, the output unit 13 may be connected by a wire to the input unit 21.

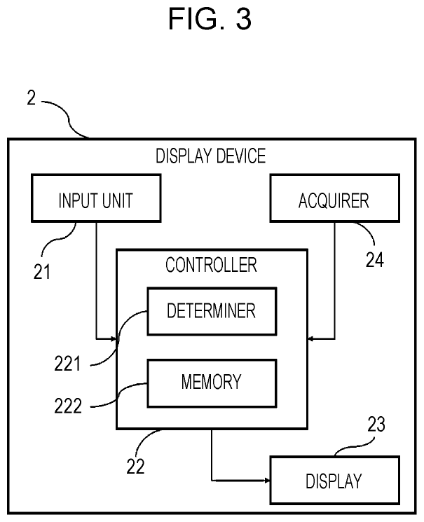

FIG. 3 is a functional block diagram of the display device 2 included in the first embodiment of the payment processing system.

The display device 2 includes the input unit 21, a controller 22, a display 23, and an acquirer 24.

The input unit 21 accepts an input of identification information output from the output unit 13 included in the imaging device 1. The input unit 21 then transmits the accepted identification information to the controller 22.

As illustrated in FIG. 3, the controller 22 includes a determiner 221 and a memory 222.

The determiner 221 performs various types of determination processing described below.

The determiner 221 includes a processor. The processor may be a central processing unit (CPU), a graphics processing unit (GPU), or a field-programmable gate array (FPGA).

The memory 222 stores, for example, various types of information or parameters related to the operation of the display device 2. That is, data related to the functions of the display device 2 and various types of information received by and output from the controller 22 are all processed through the memory 222. The memory 222 may store programs executed by the determiner 221. The memory 222 may function as a working memory for the determiner 221. The memory 222 may store a captured image, identification information, or a display image (described below).

The memory 222 may be a semiconductor memory, a magnetic memory, or an optical memory. The semiconductor memory may be a volatile memory or a non-volatile memory. The magnetic memory may be a hard disk or a magnetic tape. The optical memory may be a compact disc (CD), a digital versatile disc (DVD), or a Blu-ray (registered trademark) disc (BD).

On the basis of external output information from the cash register 3 received by the acquirer 24, the determiner 221 generates a display image containing identification information transmitted from the input unit 21, and determines whether to update and display the display image on the display 23. The term “update and display” means to update a display image already displayed on the display 23. That is, when two or more pieces of identification information are transmitted to the determiner 221, the “update and display” may mean display processing which involves displaying a display image containing first identification information on the display 23, displaying identification information containing second identification information on the display 23, and then displaying identification information containing third identification information on the display 23. Details of the external output information will be described later on, along with the description of the acquirer 24.

The display image may be generated after correction processing, such as trimming or rearrangement of identification information, for a reader 31 of the cash register 3 to easily read the identification information.

For the determiner 221 to update and display a display image on the display 23, the cash register 3 is required to detect identification information and identify/register an imaging object. That is, the determiner 221 determines, on the basis of external output information, whether the cash register 3 has detected identification information and has identified/registered an imaging object.

When the determiner 221 determines that the cash register 3 has detected identification information contained in the display image and has identified an imaging object, the determiner 221 updates and displays the display image on the display 23.

The “update and display” may mean, for example, to display a whiteout that occurs by stopping a pre-update display image before displaying a post-update display image, or to display an image not containing identification information.

The controller 22 causes the display 23 to display a display image to the reader 31.

The display 23 includes a display device, such as a liquid crystal display, an organic EL (or emitting diode) display, or an inorganic EL display.

The acquirer 24 acquires external output information from the cash register 3 and transmits the acquired external output information to the determiner 221. Details of the acquirer 24 will be described later on.

As illustrated in FIG. 1, the cash register 3 includes the reader 31, an identifier 32, a computer processor 33, an operation screen 34, and a speaker 35. The operation screen 34 or the speaker 35 may be optional.

The reader 31 reads and analyzes identification information displayed on the display 23 included in the display device 2, and acquires a management code used to identify the type of an imaging object. The management code is associated with the item name of the imaging object. For example, the management code may be a JAN code. The reader 31 transmits the acquired management code to the identifier 32.

The reader 31 may be, for example, an optical reader. The optical reader may be, for example, a pen reader, a CCD touch reader, a laser scanner, a two-dimensional barcode reader, or a stationary barcode reader.

The identifier 32 identifies an imaging object on the basis of the management code acquired by the reader 31. Identifying an imaging object involves identifying the item name or the price of the imaging object.

The computer processor 33 performs registration/payment processing on the basis of, for example, the item name or the price of the imaging object identified by the identifier 32. The registration processing may be, for example, calculating the price of one imaging object identified by the identifier 32 and registering the imaging object and the price on a list. The computer processor 33 may calculate the sum of the prices of imaging objects registered on the list. The payment processing may mean making payment on the basis of the sum of the prices of one or more imaging objects registered on the list during execution of the payment processing.

The identifier 32 and the computer processor 33 include a processor and a memory. The processor may be a central processing unit (CPU), a graphics processing unit (GPU), or a field-programmable gate array (FPGA). The memory may be a semiconductor memory, a magnetic memory, or an optical memory. The semiconductor memory may be a volatile memory or a non-volatile memory. The magnetic memory may be, for example, a hard disk or a magnetic tape. The optical memory may be, for example, a compact disc (CD), a digital versatile disc (DVD), or a Blu-ray (registered trademark) disc (BD).

The memory included in the identifier 32 and the computer processor 33 may store various types of information or parameters related to the operation of the cash register 3. The memory may store programs executed by the identifier 32 and the computer processor 33. The memory may function as a working memory for the identifier 32 and the computer processor 33.

The identifier 32 and the computer processor 33 may share part of or the entire processor and memory, or may each include a processor and a memory.

The operation screen 34 displays data related to imaging objects identified, registered, or subjected to payment processing by the identifier 32 and the computer processor 33. The operation screen 34 thus functions as an interface for the user to operate the cash register 3. Examples of the user operation performed on the cash register 3 through the operation screen 34 include correcting the result of registration/payment processing performed by the computer processor 33, and confirming the result of payment processing.

The operation screen 34 includes a display device, such as a liquid crystal display, an organic EL (or emitting diode) display, or an inorganic EL display. An operation on the operation screen 34 may be a touch operation, a keyboard operation, a mouse operation, or a trackball operation. When the operation on the operation screen 34 is a touch operation, the operation screen 34 may be a pressure-sensitive or electrostatic touch panel. When the operation on the operation screen 34 is a keyboard operation, a mouse operation, or a trackball operation, the operation screen 34 may be provided with an input keyboard, a mouse, or a trackball.

The speaker 35 outputs a read sound when the computer processor 33 identifies and registers an imaging object.

The speaker 35 includes, for example, a piezoelectric speaker. A read sound output by the speaker 35 may be, for example, a beep or voice. The read sound may vary depending on, for example, whether the computer processor 33 has succeeded in registration processing.

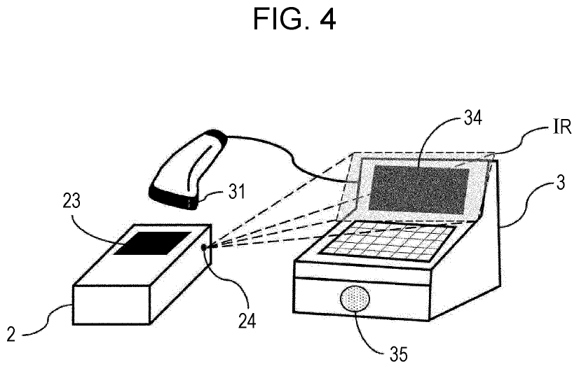

External output information acquired by the acquirer 24 and a method of determination processing performed by the determiner 221, according to the first embodiment, will now be described by using FIGS. 4 to 6.

FIG. 4 is a diagram illustrating an image of how the acquirer 24 acquires external output information. As illustrated in FIG. 4, the acquirer 24 captures an image in an imaging range IR including the operation screen 34 as external output information from the cash register 3. The acquirer 24 transmits the acquired captured image to the determiner 221. The determiner 221 makes a determination on the basis of the acquired captured image.

In the first embodiment, the acquirer 24 includes a camera. The camera includes an imaging optical system and an imaging element. The imaging optical system includes, for example, optical members, such as one or more lenses and an aperture stop. The lens may be a lens of any focal length. For example, the lens may be a commonly used lens, a wide-angle lens such as a fisheye lens, or a zoom lens with a variable focal length. The imaging optical system forms a subject image on a light receiving surface of the imaging element. The imaging element is, for example, a charge coupled device (CCD) image sensor or a complementary metal-oxide semiconductor (CMOS) image sensor. The imaging element captures the subject image formed on the light receiving surface and generates a captured image. The imager 11 may continuously capture still images at any frame rate. Continuously capturing still images may mean capturing a moving image.

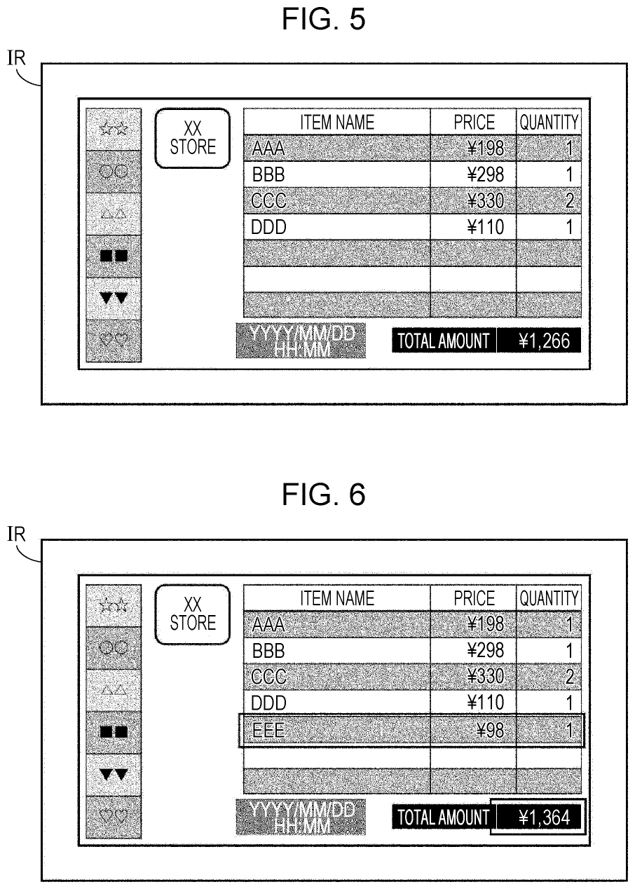

FIG. 5 and FIG. 6 are diagrams illustrating pre-update and post-update images, respectively, of external output information on the operation screen, acquired by the display device. Differences between FIG. 5 and FIG. 6 are surrounded by frames in FIG. 6. As indicated, an item EEE is added and the total amount is updated in FIG. 6.

The determiner 221 detects changes in the operation screen 34, such as those illustrated in FIG. 5 and FIG. 6, through a captured image acquired by the acquirer 24.

When the acquirer 24 continuously captures still images to generate a captured image, a registered imaging object may be added and the total amount may be updated, as illustrated in FIG. 6. In this case, the determiner 221 may determine, on the basis of the occurrence of changes in the generated captured image, that the cash register 3 has detected identification information and has identified/registered the imaging object.

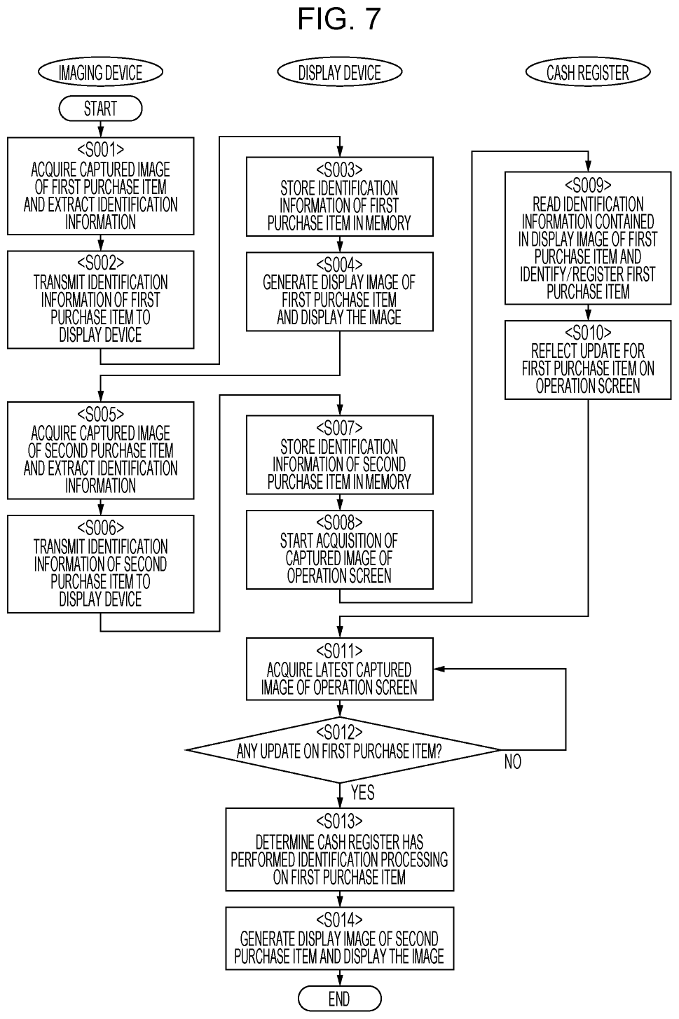

By using FIG. 7, an update and display processing flow in the display device 2, according to the first embodiment, will be described while referring to processing in the imaging device 1 and the cash register 3. The description herein assumes that there are two imaging objects, a first purchase item and a second purchase item. The processing flow may be constructed in such a way that the same and/or similar processing can be performed on three or more imaging objects on the basis of the description herein. This also applies to the description of update and display processing flows in second and third embodiments.

<S001>

The imaging device 1 causes the imager 11 to capture an image of a first purchase item to generate a captured image, and causes the extractor 12 to extract identification information of the first purchase item from the captured image. Then, the process proceeds to <S002>.

<S002>

After the extractor 12 extracts the identification information of the first purchase item, the imaging device 1 causes the output unit 13 to transmit the identification information of the first purchase item to the display device 2. Then, the process proceeds to <S003>.

<S003>

After the output unit 13 transmits the identification information of the first purchase item to the display device 2, the display device 2 stores, in the memory 222, the identification information of the first purchase item transmitted from the imaging device 1 to the input unit 21. Then, the process proceeds to <S004>.

<S004>

After the memory 222 stores therein the identification information of the first purchase item, the display device 2 confirms that no image is displayed on the display 23 at this point. The display device 2 then causes the determiner 221 to generate a display image containing the identification information of the first purchase item, and causes the display 23 to display the display image containing the identification information of the first purchase item. Then, the process proceeds to <S005>.

<S005>

After the display 23 displays the display image containing the identification information of the first purchase item, the imaging device 1 causes the imager 11 to capture an image of a second purchase item to generate a captured image, and causes the extractor 12 to extract identification information of the second purchase item from the captured image. Then, the process proceeds to <S006>.

<S006>

After the extractor 12 extracts the identification information of the second purchase item, the imaging device 1 causes the output unit 13 to transmit the identification information of the second purchase item to the display device 2. Then, the process proceeds to <S007>.

<S007>

After the output unit 13 transmits the identification information of the second purchase item to the display device 2, the display device 2 stores, in the memory 222, the identification information of the second purchase item transmitted from the imaging device 1 to the input unit 21. Then, the process proceeds to <S008>.

<S008>

After the memory 222 stores therein the identification information of the second purchase item, the display device 2 causes the acquirer 24 to start acquisition of a captured image of the operation screen 34 included in the cash register 3. The acquired captured image of the operation screen 34 is sequentially transmitted to the determiner 221. Then, the process proceeds to <S009>.

<S009>

After the acquirer 24 starts acquisition of a captured image of the operation screen 34 included in the cash register 3, the cash register 3 causes the reader 31 to read the identification information contained in the display image of the first purchase item, and causes the identifier 32 and the computer processor 33 to identify/register the first purchase item. Then, the process proceeds to <S010>.

<S010>

After the identifier 32 and the computer processor 33 identify/register the first purchase item, the cash register 3 reflects the update on the identified/registered first purchase item on the operation screen 34. Then, the process proceeds to <S011>.

<S011>

After the update on the registered first purchase item is reflected on the operation screen 34, or if the determiner 221 determines in <S012> that there has been no update on the first purchase item on the operation screen 34, the display device 2 causes the acquirer 24 to acquire the latest captured image of the operation screen 34 included in the cash register 3. Since the acquisition of a captured image has started in <S008>, the display device 2 is assumed to have at least two captured images at this point. Then, the process proceeds to <S012>. The acquired captured images may be deleted after being stored in the memory 222 for a given period of time.

<S012>

After the acquirer 24 acquires the latest captured image of the operation screen 34 included in the cash register 3, the display device 2 causes the determiner 221 to determine, from the captured image of the operation screen 34 acquired by the acquirer 24, whether there has been any update on the registered first purchase item on the operation screen 34. In other words, on the basis of the captured image of the operation screen 34 acquired by the acquirer 24, the determiner 221 determines whether the cash register 3 has detected the identification information of the first purchase item and has identified/registered the first purchase item. If the determiner 221 determines that there has been an update on the first purchase item, the process proceeds to <S013>. If the determiner 221 determines that there has been no update on the first purchase item, the process returns to <S011>.

<S013>

If the determiner 221 determines that there has been an update on the first purchase item on the operation screen 34, the display device 2 causes the determiner 221 to determine that the cash register 3 has detected the identification information of the first purchase item and has identified/registered the first purchase item. Then, the process proceeds to <S014>.

<S014>

If the determiner 221 determines that the cash register 3 has detected the identification information of the first purchase item and has identified/registered the first purchase item, the display device 2 causes the determiner 221 to generate a display image containing identification information of a second purchase item, and causes the display 23 to display the generated display image, in place of the display image containing the identification information of the first purchase item.

### Second Embodiment

In the first embodiment, a display image on the display 23 is updated on the basis of changes in the operation screen 34 of the cash register 3. In a second embodiment, a display image on the display 23 is updated on the basis of an output sound from the speaker 35 of the cash register 3.

The second embodiment will be described, with a focus on differences from the first embodiment.

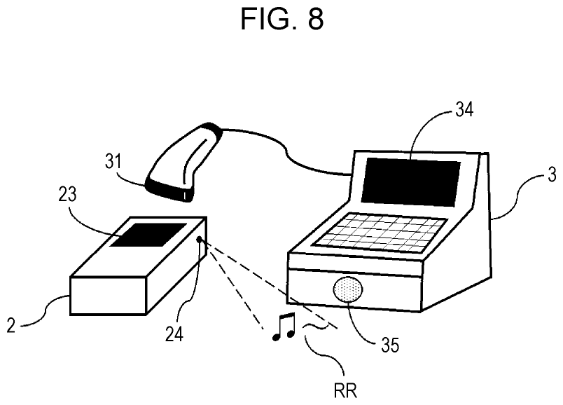

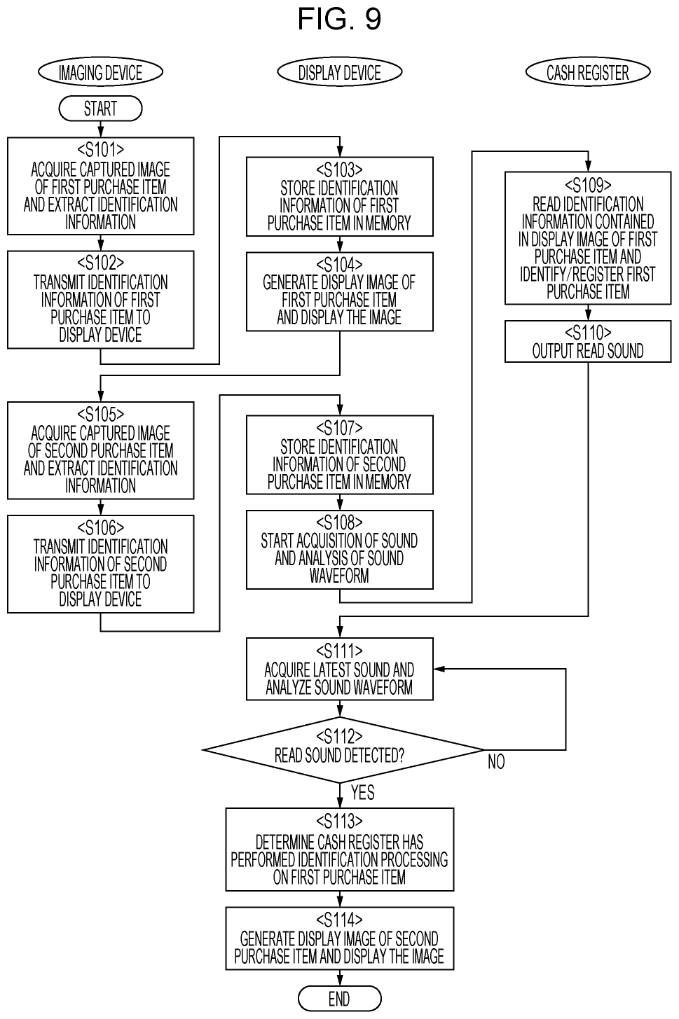

By using FIG. 8 and FIG. 9, external output information acquired by the acquirer 24 and a determination processing method performed by the determiner 221, according to the second embodiment, will be described.

FIG. 8 is a diagram illustrating an image of how the acquirer 24 acquires external output information. As illustrated in FIG. 8, the acquirer 24 collects an output sound from the cash register 3, in a collectable state, as external output information of the cash register 3, and transmits the acquired sound to the determiner 221. The output sound may be, for example, a read sound output from the speaker 35. The determiner 221 makes a determination on the basis of the acquired sound.

In the second embodiment, the acquirer 24 includes one or more microphones. The microphone may be, for example, a capacitor microphone or a dynamic microphone. The microphone may have directivity that enables precise collection of a read sound output from the speaker 35.

The determiner 221 learns a sound waveform corresponding to the read sound in advance, and attempts to detect a sound waveform corresponding to the read sound from the sound acquired by the acquirer 24. To detect a sound waveform, the determiner 221 may use, for example, a pattern matching technique, such as dynamic programming (DP) matching, or other known sound recognition/matching techniques.

The determiner 221 may determine, when determining that a sound waveform corresponding to the read sound has been detected, that the cash register 3 has detected identification information and has identified/registered an imaging object.

By using FIG. 9, an update and display processing flow in the display device 2, according to the second embodiment, will be described while referring to processing in the imaging device 1 and the cash register 3.

<S101> to <S107>

The description of steps <S101> to <S107>, which are equivalent to <S001> to <S007> in the first embodiment, is omitted here. After the memory 222 stores the identification information of the second purchase item in <S107>, the process proceeds to <S108>.

<S108>

After the memory 222 stores therein the identification information of the second purchase item, the display device 2 causes the acquirer 24 to start acquisition of a sound. The sound acquired here is sequentially transmitted to the determiner 221, which analyzes the sound waveform. Then, the process proceeds to <S109>.

<S109>

After the acquirer 24 starts acquisition of a sound and the determiner 221 starts analysis of a sound waveform, the cash register 3 causes the reader 31 to read the identification information of the first purchase item, contained in the display image, and causes the identifier 32 and the computer processor 33 to identify/register the first purchase item. Then, the process proceeds to <S110>.

<S110>

After the identifier 32 and the computer processor 33 identify/register the first purchase item, the cash register 3 outputs, from the speaker 35, a read sound indicating that the first purchase item has been identified/registered. Then, the process proceeds to <S111>.

<S111>

After the read sound is output from the speaker 35, or if the determiner 221 determines in <S112> that the sound waveform corresponding to the read sound has not been detected, the display device 2 causes the acquirer 24 to acquire the latest sound and transmit it to the determiner 221, which analyzes the sound waveform. Then, the process proceeds to <S112>.

<S112>

After the acquirer 24 acquires the latest sound and the determiner 221 analyzes the sound waveform, the display device 2 causes the determiner 221 to determine whether a sound waveform corresponding to the read sound has been detected. In other words, on the basis of the sound acquired by the acquirer 24, the determiner 221 determines whether the cash register 3 has detected the identification information of the first purchase item and has identified/registered the first purchase item. If the determiner 221 determines that the sound waveform corresponding to the read sound has been detected, the process proceeds to <S113>. If the determiner 221 determines that the sound waveform corresponding to the read sound has not been detected, the process returns to <S111>.

<S113>

If the determiner 221 determines that the sound waveform corresponding to the read sound has been detected, the display device 2 causes the determiner 221 to determine whether the cash register 3 has detected the identification information of the first purchase item and has identified/registered the first purchase item. Then, the process proceeds to <S114>.

<S114>

If the determiner 221 determines that the cash register 3 has identified the identification information of the first purchase item and has identified/registered the first purchase item, the display device 2 causes the determiner 221 to generate a display image containing identification information of a second purchase item, and causes the display 23 to display the generated display image, in place of the display image containing the identification information of the first purchase item.

### Third Embodiment

In the second embodiment, a display image on the display 23 is updated on the basis of an output sound from the speaker 35 of the cash register 3. In a third embodiment, a display image on the display 23 is updated on the basis of changes in the operation screen 34 of the cash register 3 and an output sound of the speaker 35. In other words, the third embodiment is a combination of the first and second embodiments.

In the third embodiment, the acquirer 24 includes a camera and a microphone. The configurations of the camera and the microphone are the same as those described in the first and second embodiments.

The determiner 221 determines whether the acquirer 24 has detected a change in the operation screen 34 and the output sound of the speaker 35 at substantially the same time. The term “substantially the same time” means that the outputs from the cash register 3 in registering the same imaging object take place within an allowable range of time. That is, the determiner 221 may appropriately adjust the allowable range of “substantially the same time” in accordance with the specifications of the cash register 3 to be used.

The determiner 221 may determine, when determining that acquirer 24 has detected a change in the operation screen 34 and the output sound of the speaker 35 at substantially the same time, that the cash register 3 has detected the identification information and has identified/registered an imaging object.

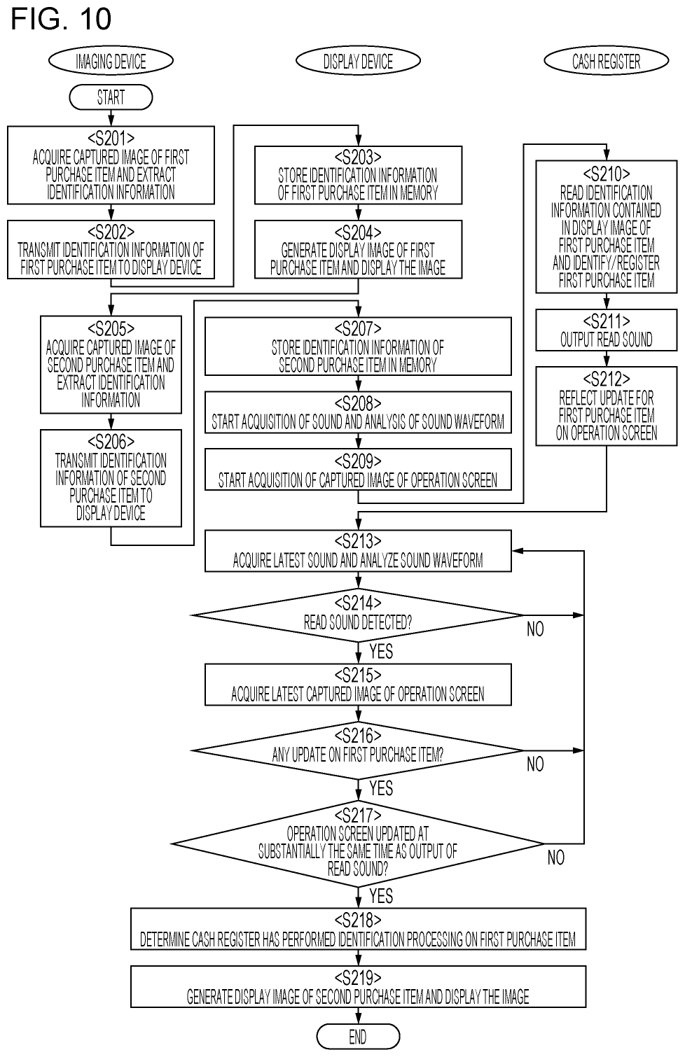

By using FIG. 10, an update and display processing flow in the display device 2, according to the second embodiment, will be described while referring to processing in the imaging device 1 and the cash register 3.

<S201> to <S207>

The description of steps <S201> to <S207>, which are equivalent to <S001> to <S007> in the first embodiment, is omitted here. After the memory 222 stores the identification information of the second purchase item in <S207>, the process proceeds to <S208>.

<S208>

After the memory 222 stores therein the identification information of the second purchase item, the display device 2 causes the acquirer 24 to start acquisition of a sound. The sound acquired here is sequentially transmitted to the determiner 221, which analyzes the sound waveform. Then, the process proceeds to <S209>.

<S209>

After the acquirer 24 starts acquisition of a sound and the determiner 221 starts analysis of a sound waveform, the display device 2 causes the acquirer 24 to start acquisition of a captured image of the operation screen 34 included in the cash register 3. Then, the process proceeds to <S210>.

<S210>

After the acquirer 24 starts acquisition of a captured image of the operation screen 34 included in the cash register 3, the cash register 3 causes the reader 31 to read the identification information contained in the display image of the first purchase item, and causes the identifier 32 and the computer processor 33 to identify/register the first purchase item. Then, the process proceeds to <S211>.

<S211>

After the identifier 32 and the computer processor 33 identify/register the first purchase item, the cash register 3 outputs, from the speaker 35, a read sound indicating that the first purchase item has been registered. Then, the process proceeds to <S212>.

<S212>

After the read sound is output from the speaker 35, the cash register 3 reflects the update on the registered first purchase item on the operation screen 34. Then, the process proceeds to <S213>.

<S213>

After the read sound is output from the speaker 35, or if the determiner 221 determines in <S214> that the sound waveform corresponding to the read sound has not been detected, determines in <S216> that there has been no update on the first purchase item on the operation screen 34, or determines in <S217> that the operation screen 34 has not been updated at substantially the same time as the output of the read sound, the display device 2 causes the acquirer 24 to acquire the latest sound and transmit it to the determiner 221, which analyzes the sound waveform. Then, the process proceeds to <S214>.

<S214>

After the acquirer 24 acquires the latest sound and the determiner 221 analyzes the sound waveform, the display device 2 causes the determiner 221 to determine whether a sound waveform corresponding to the read sound has been detected. In other words, on the basis of the sound acquired by the acquirer 24, the determiner 221 determines whether the cash register 3 has detected the identification information of the first purchase item and has identified/registered the first purchase item. If the determiner 221 determines that the sound waveform corresponding to the read sound has been detected, the process proceeds to <S215>. If the determiner 221 determines that the sound waveform corresponding to the read sound has not been detected, the process returns to <S213>.

<S215>

If the determiner 221 determines that the sound waveform corresponding to the read sound has been detected, the display device 2 causes the acquirer 24 to acquire the latest captured image of the operation screen 34 included in the cash register 3. Since the acquisition of a captured image has started in <S209>, the display device 2 is assumed to have at least two captured images at this point. Then, the process proceeds to <S216>. The acquired captured images may be deleted after being stored in the memory 222 for a given period of time.

<S216>

After the acquirer 24 acquires the latest captured image of the operation screen 34 included in the cash register 3, the display device 2 causes the determiner 221 to determine, from the captured image of the operation screen 34 acquired by the acquirer 24, whether there has been any update on the registered first purchase item on the operation screen 34. In other words, on the basis of the captured image of the operation screen 34 acquired by the acquirer 24, the determiner 221 determines whether the cash register 3 has detected the identification information of the first purchase item and has identified/registered the first purchase item. If the determiner 221 determines that there has been an update on the first purchase item, the process proceeds to <S217>. If the determiner 221 determines that there has been no update on the first purchase item, the process returns to <S213>.

<S217>

If the determiner 221 determines that there has been an update on the first purchase item on the operation screen 34, the display device 2 causes the determiner 221 to determine, from the captured image of the operation screen 34 acquired by the acquirer 24, whether the registered first purchase item has been updated on the operation screen 34 within the range of substantially the same time as the detection of the sound waveform corresponding to the read sound. If the determiner 221 determines that the first purchase item has been updated within the range of substantially the same time as the detection of the sound waveform corresponding to the read sound, the process proceeds to <S218>. If the determiner 221 determines that there has been no update on the first purchase item within the range of substantially the same time as the detection of the sound waveform corresponding to the read sound, the process returns to <S213>.

<S218>

If the determiner 221 determines that the sound waveform corresponding to the read sound has been detected within the range of substantially the same time as the detection of the sound waveform corresponding to the read sound, the display device 2 causes the determiner 221 to determine that the cash register 3 has detected the identification information of the first purchase item and has identified/registered the first purchase item. Then, the process proceeds to <S219>.

<S219>

If the determiner 221 determines that the cash register 3 has detected the identification information of the first purchase item and has identified/registered the first purchase item, the display device 2 causes the determiner 221 to generate a display image containing identification information of a second purchase item, and causes the display 23 to display the generated display image, in place of the display image containing the identification information of the first purchase item.

Although the display device and the display method of the present disclosure have been described on the basis of the drawings and embodiments, it is to be noted that any person skilled in the art can easily make various alternative embodiments and amendments on the basis of the present disclosure.

For example, functions, means, and steps described in embodiments can be rearranged in a logically non-contradictory way. A plurality of means or steps may be combined into a single one, or may each be divided.

For the update and display on the display 23 included in the display device 2 described, for example, in paragraph (0037), if the first purchase item and the second purchase item are the same items, the display images containing the same identification information are displayed in succession. This may cause a problem in updating and displaying, depending on the specifications of the cash register 3. Therefore, for example, the determiner 221 may determine whether the first purchase item and the second purchase item are the same items. Then, if the first purchase item and the second purchase item are the same items, the determiner 221 may set a standby time of a predetermined length before a post-update display image is displayed in updating and displaying on the display 23. During the standby time, the display 23 may display a whiteout display image or a display image not containing identification information.

Although the display device and the display method have been described as a solution in the present disclosure, the present disclosure may be implemented as an embodiment including the display device and the display method, or may be implemented as a system, a program, and a storage medium recording the program that are substantially equivalent to the display device and the display method. It is to be understood, therefore, that such a system, a program, and a storage medium are also included in the scope of the present disclosure.

### REFERENCE SIGNS

1 imaging device
11 imager
12 extractor
13 output unit
2 display device
21 input unit
22 controller
221 determiner
222 memory
23 display
24 acquirer
3 cash register
31 reader
32 identifier
33 computer processor
34 operation screen
35 speaker

1. A display device comprising:
a display configured to display a first image containing identification information of a purchase item;
an acquirer configured to receive external output information from the cash register; and
a controller configured to control the display based on the external output information, wherein
when the controller determines, based on the external output information of a first purchase item, that a register has identified the first purchase item, the controller causes the display to display the second image containing the identification information of a second purchase item.

2. The display device according to claim 1, wherein the identification information of the purchased item is either a one-dimensional barcode or a two-dimensional barcode.

3. The display device according to claim 1, wherein the acquirer includes a camera; and
the acquirer is further configured to receive, as the external output information, a captured image captured by the camera.

4. The display device according to claim 3, wherein the captured image contains an operation screen of the register.

5. The display device according to claim 4, wherein upon detecting a change in the operation screen, the controller is further configured to determine determines that the register has identified the first purchase item.

6. The display device according to claim 1, wherein the acquirer includes a microphone; and
the acquirer is further configured to receive, as the external output information, a sound received by the microphone.

7. The display device according to claim 6, wherein the sound includes an output sound from the register.

8. The display device according to claim 7, wherein upon detecting a read sound from the register as the output sound, the controller is further configured to determine that the register has identified the first purchase item.

9. The display device according to claim 1, wherein the acquirer includes a camera and a microphone;
the acquirer is further configured to receive, as the external output information, a captured image captured by the camera and a sound received by the microphone.

10. The display device according to claim 9, wherein the controller is further configured to determine that the register has identified the first purchase item upon detecting a change in an operation screen of the register and a read sound output from the register at substantially a same time, the operation screen being represented by the captured image, the read sound being the sound received by the microphone.

11. A display method comprising
displaying a display image containing identification information of a first purchase item;
receiving external output information from the register; and
displaying the display image containing the identification information of a second purchase item when determining, based on the external output information of the first purchase item from the cash register, that the cash register has identified the first purchase item.
